(19) United States
(12) Patent Application Publication
(10) Pub. No.: US 2005/0093298 A1
(43) Pub. Date: May 5, 2005

(54) Connecting structure with quick connector for piping

(76) Inventor: Akira Takayanagi, Aichi-ken (JP)

Correspondence Address: Joseph J. Jochman;ANDRUS, SCEALES, STARKE & SAWALL, LLP, Suite 1100, 100 East Wisconsin Avenue, Milwaukee, WI, 53202-4178, US

(21) Appl. No.: 10/977,253

(22) Filed: Oct. 29, 2004

(30) Foreign Application Priority Data
Oct. 31, 2003 (JP) 2003-373813
Oct. 22, 2004 (JP) 2004-308948

(51) Int. Cl. F16L 47/00

(52) U.S. Cl. 285/319; 285/239; 285/921

(57) ABSTRACT

First, second and third O-rings are disposed in an inner peripheral surface of a resin tube connecting portion of a connector housing. A resin tube is connected to the resin tube connecting portion while fitted thereon such that an opposite axial end of a fit-on portion of the resin tube reaches an opposite axial end of the resin tube connecting portion and the opposite axial end of the fit-on portion of the resin tube is located substantially on an axial position of the third O-ring. The tubular connector housing is made of resin and the resin tube has a barrier layer against gasoline fuel or the like.

### BACKGROUND OF THE INVENTION

1. Technical Field

The present invention relates to a connecting structure for piping, to be adapted for piping assembly of an automobile or the like for conveying internal fluid such as gasoline, alcohol blended gasoline, compressed natural gas (CNG), liquefied petroleum gas (LPG), alcohol, dim ethyl ether (DME), fuel for fuel-cell hybrid vehicle or the like, more specifically, to a connecting structure with quick connector for piping in order to restrain permeation of the internal fluid such as gasoline fuel or the like through a joint in piping or a connector connecting portion as low as possible.

2. Background Art

In a gasoline fuel piping structure of an automobile, a quick connector such as shown in Patent Document 1 is used for joining a tube to a pipe. The quick connector has a tubular connector housing and a retainer fitted in the tubular connector housing. The tubular connector housing is provided with a resin tube connecting portion on one axial end thereof and a pipe inserting portion on an opposite axial end thereof, and the pipe inserting portion has a retainer holding portion on au opposite axial end thereof wherein the retainer is fitted. A pipe is relatively inserted into an insertion opening on an end of the tubular connector housing, the pipe inserting portion or the retainer holding portion so as to snap-fit in the quick connector, and thereby the quick connector is connected to the pipe. A pipe to be connected to the quick connector is formed with an inserting end portion on one axial end thereof, and the inserting end portion of the pipe is provided with an annular engagement projection on an outer peripheral surface thereof. The inserting end portion of the pipe is inserted in the pipe inserting portion of the tubular connector housing, the annular engagement projection snap-engages with the retainer, and thereby the pipe snap-fits in the quick connector.

The pipe inserting portion has a seal holding portion which is formed smaller in diameter than the retainer holding portion on one axial end of the retainer holding portion. Sealing means is disposed in the seal holding portion on one axial end thereof to provide a seal between the pipe inserting portion and the inserting end portion of the pipe, more specifically, one end portion of the inserting end portion extending axially from the annular engagement projection. The sealing means comprises annular sealing member made of elastic material, which prevents gasoline fuel from leaking out between the tubular connector housing and the pipe.
[Patent Document 1] JP, A, 10-231980

Meanwhile, relatively large amount of gasoline fuel permeates and leaks into the air through a connector connecting portion in a gasoline fuel piping. In order to deal with environmental problems by restraining such permeation of gasoline fuel to low level, it is preferred to construct sealing means with elastic materials of low permeability to gasoline fuel. Therefore, if sealing means is constructed by one annular sealing member, fluoro-rubber (FKM), acrylonitrile-butadiene rubber (NBR), acrylonitrile-butadiene rubber/polyvinyl chloride blend rubber (NBR/PVC) or fluoro-rubber/fluoro-silicone-rubber blend rubber (FKM/FVMQ) is used for the annular sealing member in many cases. On the other hand, as shown specifically in Patent Document 1, if the sealing means is constructed by two annular sealing members, disposed axially in side by side relation, the annular sealing member of one axial end to be contacted directly with gasoline fuel is typically made of FKM or FKM/FVMQ in view of gasoline fuel impermeability or low gasoline fuel permeability, and the annular sealing member of an opposite axial end is typically made of fluoro-silicone-rubber (FVMQ), NBR or NBR/PVC in view of low-temperature resistant property.

Although such sealing means is provided, even in this construction, gasoline fuel permeation amount through a connector connecting portion is still large compared to that through other portions in fuel piping system. Considering current situation where regulations become extremely tighten against permeation of gasoline fuel from fuel piping system in an automobile, gasoline fuel impermeability of the quick connector or the connector connecting portion should be further improved. It is considered that gasoline fuel impermeability of the connector connecting portion is effectively improved by further reducing gasoline fuel permeation amount through a connector housing A (refer to an arrow of FIG. 10). In other words, it is necessary to restrain a permeation amount of gasoline fuel through a portion B of the connector housing A which contacts direct with gasoline fuel and of which outer surface side is exposed. Here, it is possible to reduce permeation amount of the gasoline fuel through the portion B of the connector housing A or the connector connecting portion by selecting a suitable material for the connector housing A. However, selection of the material for the connector housing A cannot be a key solution of the problem as it might be limited in a view of cost or other functions required for the connector housing A.

Accordingly, it is an object of the present invention to provide a connecting structure with quick connector for piping having versatile configuration which may sufficiently reduce permeation amount of an internal fluid such as gasoline fuel or the like.

### SUMMARY OF TH INVENTION

In order to achieve a foregoing object, according to the present invention, there is provided a novel connecting structure for piping to connect a tube and a pipe by way of a quick connector and to establish fuel communication path. In the connecting structure for piping according to the present invention, the quick connector has a tubular connector housing provided with a tube connecting portion on one axial end thereof and a retainer portion to which a retainer is configured or provided on an opposite axial end thereof, retainer means provided to the retainer portion, and sealing means disposed in the tubular connector housing. The pipe includes an inserting end portion provided with an annular engagement projection. The pipe or the inserting end portion of the pipe is inserted into an insertion opening on an end of the tubular connector housing and connected to the tubular connector housing so that the annular engagement projection snap-engages with the retainer means and a seal is provided between the tubular connector housing and the pipe or one end of the inserting end portion extending axially from the annular engagement projection of the pipe by the sealing means. In this state, the tube or a fit-on portion which is included in the tube is tightly fitted on an outer periphery of the tube connecting portion of the tubular connector housing, and an opposite axial end or an opposite axial edge of the fit-on portion of the tube fitted thereon is located on an opposite end axially of the sealing means.

The tubular connector housing may be made of resin. A retainer, which is fitted to a retainer portion, namely a retainer holding portion of the tubular connector housing, may be adapted for retainer means. The retainer is fitted to the retainer holding portion of the tubular connector housing, for example, by engaging the retainer in a pair of engagement windows which are formed on the retainer holding portion. An engagement slit may be formed on one axial end portion of the retainer, the annular engagement projection of the pipe snap-engages in the engagement slit, and thereby connection has been completed between the pipe and the quick connector.

As already described, the sealing means provides a seal between the tubular connector housing and the pipe inserted therein. More specifically, the sealing means provides a seal, for example, between the tubular connector housing and one end of the inserting end portion extending axially from the annular engagement projection of the pipe. In the present invention, such sealing means is disposed, for example, in the tube connecting portion of the tubular connector housing. Or, a seal holding portion is configured, for example, in the tube connecting portion. Therefore, the quick connector adapted in the present invention may be formed in a compact shape with short axial length compared to a quick connector where a tube connecting portion and a seal holding portion are arranged axially in side-by-side relation.

By the way, in order to restrain permeation amount of gasoline fuel or the like through the connector connecting portion to low level, it is required to reduce permeation amount of gasoline fuel or the like through a portion of the tubular connector housing which contacts direct with gasoline fuel or the like. In the quick connector, a tube is fitted on an outer periphery of the tube connecting portion of the tubular connector housing. And, in the present invention, for example, a portion of the tubular connector housing corresponding to the sealing means disposed and one end portion thereof extending axially from the sealing means disposed are covered with a tube. In such configuration, gasoline fuel or the like is covered doubly with the tubular connector housing and the tube entirely at a portion of the tubular connector housing which contacts direct with gasoline fuel or the like, and thereby permeation amount of gasoline fuel or the like can be restrained sufficiently to low level through the connector connecting portion. Further, unless the tubular connector housing is made of material of impermeability to gasoline fuel or the like, as far as the tube has sufficient impermeability to gasoline or the like (gas barrier property), it becomes possible to restrain permeation amount of gasoline fuel or the like through the connector connecting portion to a satisfactory level. The tube is provided, for example, with barrier property against gasoline fuel or the like (gas barrier property) or a barrier layer against gasoline fuel or the like (gas barrier layer) and formed from resin.

Preferably, hermetically-closing means is disposed on an outer periphery of the tube connecting portion to provide a seal between the fit-on portion of the tube and the tube connecting portion. By constructing in such manner, it is effectively prevented that gasoline or the like, or gaseous gasoline or the like which permeates through the tubular connector housing or the tube connecting portion further migrates and leas out in the air through between the tube connecting portion and the fit-on portion of the tube. The hermetically-closing means is, preferably, disposed so as to provide a seal between a portion near an opening of the fit-on portion of the tube or opposite axial end portion of the fit-on portion and the tube connecting portion or an opposite axial end portion thereof. The hermetically-closing means may be disposed on an opposite end axially from the sealing means. If the sealing means is constructed by a plurality of sealing members, and the sealing members are disposed axially in side-by-side relation, it is not necessarily required that hermetically-closing means is located beyond all of the sealing members in an opposite axial direction. The tube connecting portion may be provided with an annular groove around an outer periphery thereof, for example, on an opposite axial end thereof to receive the hermetically-closing means therein.

It is preferred that the tube or the resin tube is formed from base material or gas barrier base material, namely base material of the gas barrier layer which has a specific gravity ranging from 1.2 to 2.0. For example, base material of the gas barrier layer of the resin tube has a specific gravity ranging from 1.2 to 2.0. If a specific gravity of the base material is lower than 1.2, sufficient impermeability to gasoline fuel or the like cannot be ensured, for example, as its texture becomes coarse. On the other hand, if the specific gravity of the base material exceeds 2.0, elasticity of the tube is deteriorated, thereby handleability may be lowered, close contact property with the tube connecting portion accordingly sealing property is lowered when the tube is fitted on the tube connecting portion.

It is also preferred that the tubular connector housing made of resin is formed from base material which has a specific gravity ranging from 1.2 to 2.0. And, it is effective that a flexural modulus of the tubular connector housing is set at minimum 1500 MPa according to ASTM D790. If a specific gravity of the base material is lower than 1.2, a permeation amount of gasoline fuel through the tubular connector housing becomes unacceptably high. On the other hand, if the specific gravity of the base material exceeds 2.0, elasticity, therefore shock resistance is lowered. So, it tends to cause damages which could be a factor to lower impermeability to gasoline fuel. If a flexural modulus of the tubular connector housing is lower than 1500 MPa, it also tends to cause damages which could be a factor to deteriorate impermeability to gasoline fuel.

In some cases or most cases, a bush is fitted in an inside of the tube connecting portion of the connector housing on one axial end thereof, for example, in order to axially position the sealing means. Here, for example, if a flexural modulus of the connector housing is established at minimum 1500 MPa, the tube connecting portion is neither deformed nor contracts diametrically even when the resin tube fastens tightly the tube connecting portion. So, for example, if an intolerable clearance or gap is created between the tube connecting portion and the bush due to manufacturing variations and the like, even when the resin tube is fitted on the tube connecting portion, the clearance cannot be eliminated resulting in a play or rattling between the bush and the tube connecting portion. Then, it is predicted that the bush and the sealing means repeatedly conflict with one another, and thereby a sealing property of the connecting structure for piping might be deteriorated at an early stage. In order to solve this problem, the bush is configured so as to have one axial end portion projecting in one axial direction beyond one axial end of the tube connecting portion, the one end portion of the bush is dimensioned larger than the one axial end of the tube connecting portion in outer diameter, and the resin tube is to be fitted on the tube connecting portion so as to fasten tightly the one axial end portion of the bush projecting in one axial direction beyond the one axial end of the tube connecting portion. This configuration ensures the bush to be axially positioned by fitting the resin tube on the tube connecting portion. One axial end portion of the bush may be turned or folded back upon itself to form a turnback portion in order to clip an end of the tube connecting portion therein. This configuration allows to mount the bush in the tube connecting portion more stably. The bush may also configured without turn back portion so as to decrease insertion resistance with respect to the resin tube.

The connecting structure for piping according to the present invention can restrain permeation of gasoline fuel or the like through a connector connecting portion to low level with use of impermeability to gasoline fuel or the like of the tube.

Now, the preferred embodiments of the present invention will be described in detail with reference to the drawings.

### BRIEF DESCRIPTION OF THE DRAWINGS

FIG. 1 is a perspective view of a first quick connector adapted in a connecting structure for piping according to the present invention.

FIG. 2 is a cross-sectional view of the first quick connector.

FIG. 3 is an enlarged view of a periphery of a second resin bush of the first quick connector.

FIG. 4 is a perspective view of a retainer adapted to the first quick connector.

FIG. 5 is a cross-sectional view of a first connecting structure for piping according to the present invention which is constructed by connecting the first quick connector to a pipe.

FIG. 6 is a view showing multi-layered construction of a resin tube.

FIG. 7 is a view showing a comparative example of a connecting structure for piping.

FIG. 8 is a cross-sectional view of a second connecting structure for piping according to the present invention which is constructed by connecting a second quick connector to a pipe.

FIG. 9 is a cross-sectional view of a third connecting structure for piping according to the present invention which is constructed by connecting a third quick connector to a pipe.

FIG. 10 is a view showing permeating manner of gasoline fuel through a tubular connector housing

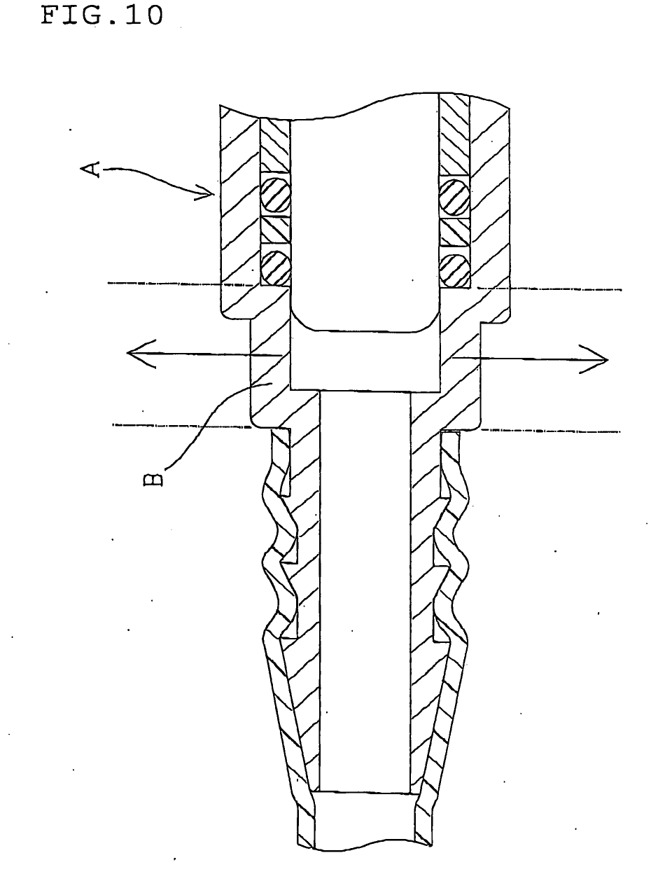

### DETAILED DESCRIPTION OF THE PREFERRED EMBODIMENTS

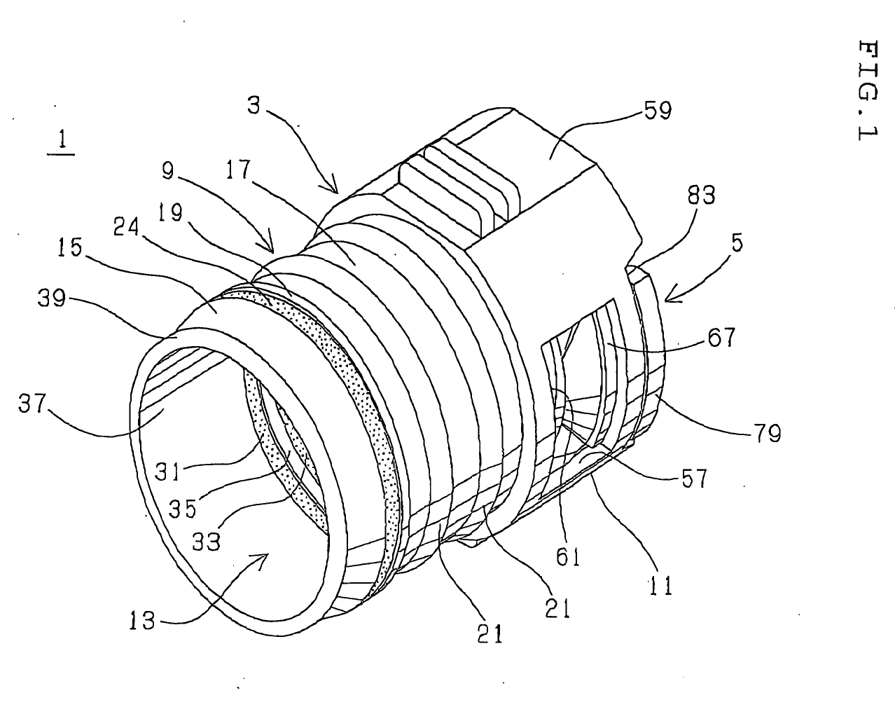

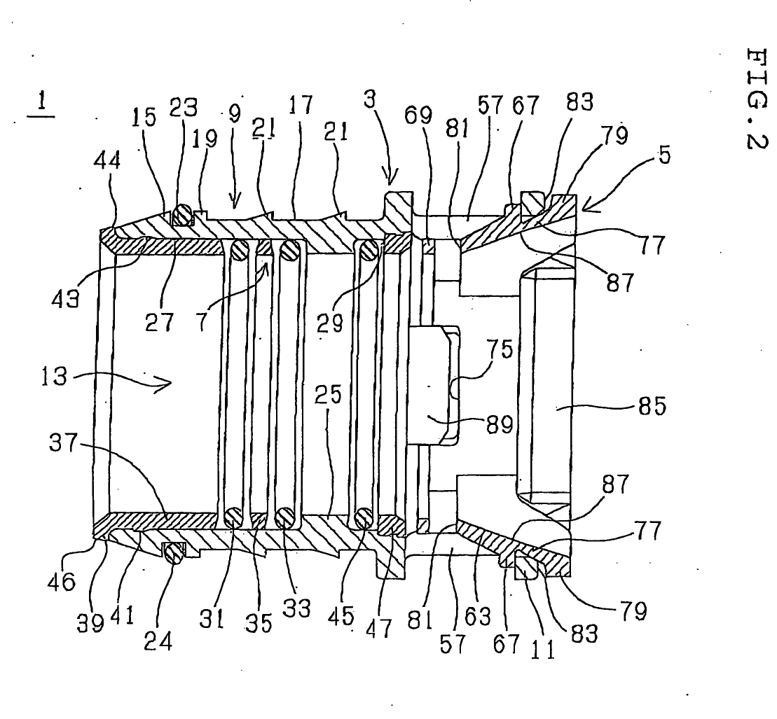

A first quick connector 1 shown in FIGS. 1 and 2, which is used in a connecting structure for piping according to the present invention, is adapted for assembly for a gasoline fuel piping of an automobile. The first quick connector 1 comprises a tubular connector housing 3, a generally annular retainer 5 and sealing means 7. The tubular connector housing 3 made of glass fiber reinforced plastic or resin, integrally has a cylindrical resin tube connecting portion 9 on one axial end thereof and a generally cylindrical retainer holding portion 11 (a retainer portion) on an opposite axial end thereof, and is provided with a through-bore 13 through from one axial end to an opposite axial end thereof. The resin tube connecting portion 9 has one axial end portion 15 like right triangle in cross-section having an outer peripheral surface expanding gently in diameter toward an opposite axial end of the resin tube connecting portion 9, and an opposite axial end portion 17 having an outer peripheral surface extending like a simple cylindrical shape on an opposite axial end of the one axial end portion 15 of the resin tube connecting portion 9. The opposite axial end portion 17 is provided on the outer peripheral surface with an annular projecting stop portion 19 like rectangular in cross-section and two annular projecting stop portions 21, 21 like right triangle in cross-section expanding in diameter toward an opposite axial end thereof. The annular projecting stop portion 19 and the annular projecting stop portions 21, 21 are arranged in axially spaced relation sequentially from one axial end to an opposite axial end of the opposite axial end portion 17. A resin tube, for example, a resin pipe member is tightly fitted on and connected to an outer periphery or an outer peripheral surface of the resin tube connecting portion 9. An outer peripheral surface 23 on one axial end portion of the opposite axial end portion 17, namely a portion between the one axial end portion 15 and the annular projecting stop portion 19 is formed in small diameter or in deep annular groove. Prior to fitting of a resin tube to the first quick connector 1, an annular seal 24 (hermetically-closing means) is fitted on the outer peripheral surface 23. The annular groove may be in formed, for example, like square or rectangular in cross-section.

An inner peripheral surface of the tubular connector housing 3 on one axial end of the retainer holding portion 11 or on one anal end of inside of the retainer holding portion 11, or an inner peripheral surface of the resin tube connecting portion 9 is formed with an inwardly directed annular parting projection 25 near an opposite axial end thereof, and is divided by the inwardly directed annular parting projection 25 into a first receiving portion 27 on one axial end and a second receiving portion 29 on an opposite anal end thereof. In the first receiving portion 27, a first O-ring 31 (sealing means) of one axial end and a second O-ring 33 (sealing means) of an opposite axial end are fitted with intervening a collar 35 therebetween, namely in axially spaced and side by side relation with one another on an opposite axial end thereof, and a first resin bush 37 is fitted on one axial end thereof. The first resin bush 37 is formed generally in a cylindrical shape, and provided integrally with an annular engagement portion 39 on one axial end portion thereof. The annular engagement portion 39 is formed so as to widen somewhat radially outwardly. The first resin bush 37 is provided with a low annular projecting portion 41 on an outer peripheral surface near one axial end thereof, and has an inner diameter substantially identical to an inner diameter of the inwardly directed annular parting projection 25. However, the annular engagement portion 39 has an inner peripheral surface expanding in diameter toward one axial end thereof. Thus configured first resin bush 37 is fitted in the first receiving portion 27 so that the annular projecting portion 41 seats in a shallow annular groove 43 formed near one axial end of the first receiving portion 27 and an outer peripheral space of an opposite axial end of the annular engagement portion 39 engages with one axial end portion of the resin tube connecting portion 9 or the one axial end portion 15. The annular engagement portion 39 has no turnback portion and projects in one axial direction beyond one axial end of the resin tube connecting portion 9, and an outer peripheral surface of one axial end of the annular engagement portion 39 is located so as to be substantially continued from an outer peripheral surface of the one axial end portion 15, just like extending an tapered outer peripheral surface of the one axial end portion 15 in one axial direction (an opposite ax end of the outer peripheral surface of the one axial end of the annular engagement portion 39 has an outer diameter generally equal to one axial end of the one axial end portion 15). More specifically, the outer peripheral surface of the one axial end of the annular engagement portion 39 slightly expands diametrically or radially outwardly (refer to numeral reference 44), and contracts diametrically (refer to numeral reference 46), in tapered manner at an angle generally equal to a tapered outer peripheral surface of the one axial end portion 15. So, the outer peripheral surface of the one axial end of the annular engagement portion 39 is dimensioned larger than the one axial end of the resin tube connecting portion 9 or the one axial end portion 15 in outer diameter. The first O-ring 31 and the second O-ring 33 are maintained in an axial position between the inwardly directed annular parting projection 25 and the first resin bush 37.

The first O-ring 31 is made of and the second O-ring 33 is also made of FKM. The collar 35 is formed of trapezoid tapered in a radially outward direction in cross-section so as to provide a room as escapeway for the first and the second O-rings 31,33 which are axially swollen when pressed by a pipe at icon of the pipe. With adapting thus configured sealing structure, it is effectively prevented that the first O-Ring 31 and the second O-ring 33, which are formed relatively in large diameter and are apt to be ed, are unacceptably deformed at insertion of a pipe.

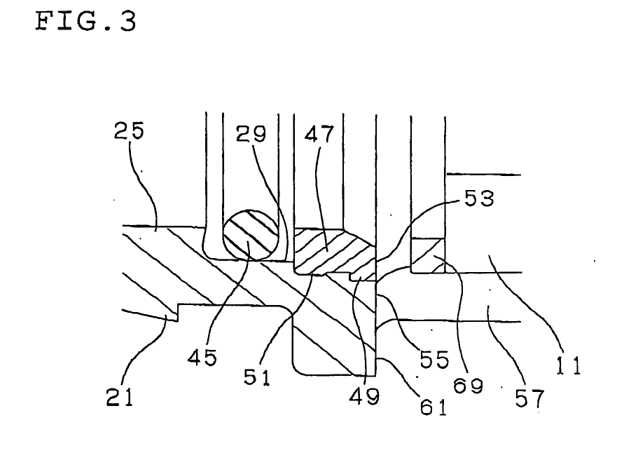

As well shown in FIG. 3, in the second receiving portion 29, a third O-ring 45 (sealing means) is fitted on one axial end, and a second resin bush 47 of annular shape is fitted on an opposite anal end of the second receiving portion 29. The second resin bush 47 integrally has a flange 49 projecting somewhat radially outwardly on an opposite axial end portion thereof, and is provided with an annular projecting portion 51 swelling somewhat radially outwardly on an outer peripheral surface of one axial end thereof. An inner peripheral surface of the second resin bush 47 has an opposite axial end surface portion expanding in diameter toward an opposite axial end or in an opposite axial direction and one axial end surface portion extending like a short cylindrical shape with an inner diameter generally identical to an inner diameter of the inwardly directed annular parting projection 25. An opposite axial end portion of the second receiving portion 29 is formed somewhat large in diameter and corresponds to an outer peripheral surface of the second resin bush 47 in shape. The second resin bush 47 is fitted in an opposite anal end portion of the second receiving portion 29 so that an annular end surface 53 on an opposite axial end thereof is located to share a plane common with an annular abutment surface or an annular inside end surface 55 formed on one axial end of inner side of the retainer holding portion 11 with narrow width extending radially inwardly. The third O-ring 45 is maintained in an axial position between the inwardly directed annular parting projection 25 and the second resin bush 47. As an opposite axial end surface of the inwardly directed annular parting projection 25 is formed toward radially outwardly inclining in one axial direction so as to provide a room as escapeway for the third O-ring 45 which is axially swollen when pressed by a pipe at insertion of the pipe. With adapting thus configured sealing structure, it is effectively prevented that the third O-ring 45, which is formed relatively in large diameter, and is apt to be deformed, is unacceptably deformed at insertion of a pipe,

Here, the third O-ring 45 is made of FKM. The third O-ring 45 may be made of FVMQ, NBR, NBR/PVC EPDM or thermoplastic olefin (TPO) as well.

The first O-ring 31, the second O-ring 33 and the third O-ring 45 construct sealing means 7. In this sealing means 7, an axial space generally corresponding to thickness of the collar 36 is secured between the first O-ring 31 and the second O-ring 33, while a axial space generally corresponding to thickness of the inwardly directed annular parting projection 25 is secured between the second O-ring 33 and the third O-ring 45. The collar 35 is thinner than the inwardly directed annular parting projection 25, specifically, generally of one-half thickness of the inwardly directed annular parting projection 25. Therefore, the axial space secured between the first O-rig 31 and the second O-ring 33 is shorter than the axial space secured between the second O-ring 33 and the third O-ring 45, specifically, generally of one-half length of the axial space secured between the second O-ring 33 and the third O-ring 45.

The generally cylindrical retainer holding portion 11 of larger diameter than the resin tube connecting portion 9, is provided with engagement windows 57, 57 in diametrically symmetrical positions and in opposed relation with one another, and flat regions 59, 59 (only one flat region 59 is shown) on the outer peripheral surfaces respectively between the engagement windows 57, 57. One axial ends or one axial end surfaces 61, 61 of the engagement windows 57, 57 are located to share a plane common with the annular abutment surface 55 of inner side of the retainer holding portion 11 and the annular end surface 53 of an opposite axial end of the second resin bush 47. That is, no step is defined on a surface between the one axial end 61 of the engagement window 57 and an edge of an opening of an opposite axial end of the second resin bush 47 or the annular end surface 53 of the second resin bush 47, and this configuration hardly permits water to remain there. Thereby such inconvenience is eliminated as water remains in a gap defined between a step and a metallic pipe connected resulting that the pipe is rusted and corroded. When a checker for verifying complete connection with a pipe is adapted, typically, engagement portions of the checker engage with the engagement windows 57, 57.

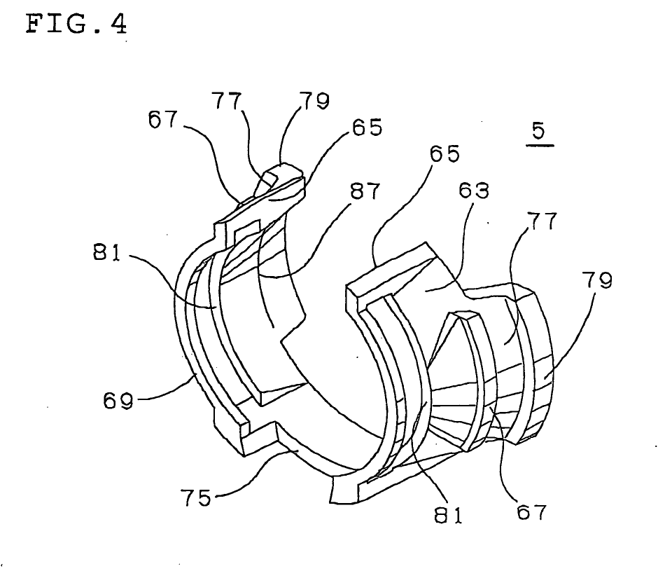

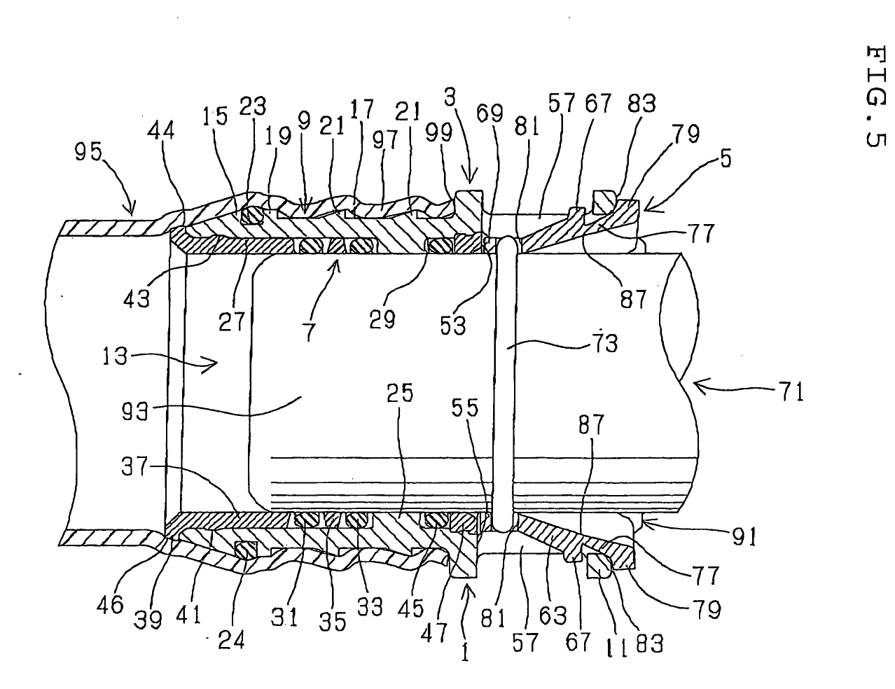

The retainer 5 made of polyamide (PA) is fitted in the retainer holding portion 11. This retainer 5 is relatively flexible, and is formed so as to be resiliently deformable. A, shown in FIG. 4, the retainer 5 has a main body 63 of C-shape in cross-section, namely generally annular shape wherein a relatively large space for deformation is defined between circumferential opposite ends 65, 65 thereof. The main body 643 is provided with a pair of engagement tabs 67, 67 projecting radially outwardly in diametrically symmetrical positions of an opposite axial end portion thereof. An inner surface of the main body 63, except a portion diametrically opposed to the space for deformation, is tapered so as to reduce gradually an inner diameter toward one axial end or in one axial direction. And, apart from the portion diametrically opposed to the space for deformation, one axial end portion 69 of the main body 63 is formed with an inner diameter almost identical to a pipe (refer to a reference numeral 71 in FIG. 5), and smaller than an annular engagement projection (refer to a reference numeral 73 in FIG. 5). The portion diametrically opposed to the space for deformation of the main body 63 has an inner surface shaped like a part of a cylindrical inner surface, and is formed with a notched portion 75 on one axial end portion 69 thereof.

A pair of short operation arms 77, 77 are formed integrally on an opposite axial end portion of the main body 63 of the retainer 5 so as to extend inclining radially outwardly in an opposite axial direction from respective circumferential positions corresponding to the engagement tabs 67, 67. The operation arms 77, 77 respectively, has a latching end 79 projecting radially outwardly on an opposite axial end portion thereof. The one axial end portion 69 of the main body 63 is provided with engagement slits 81, 81 extending circumferentially in opposed relation with one another. Thus configured retainer 5 is inserted and fitted in the retainer holding portion 11 so that the engagement tabs 67, 67 seat in the engagement windows 57, 57 of the retainer holding portion 11 and the latching ends 79, 79 fit in recessed receiving portions 83, 83 of the retainer holding portion 11 in engagement relation therewith respectively. The recessed receiving portions 83, 83 are formed in diametrically symmetrical positions of an opposite axial end portion 85 of the retainer holding portion 11. As the latching end 79 of the operation arm 77 is received in thus arranged recessed receiving portion 83, it is prevented that the retainer 5 moves from its correct fit-in position in the retainer holding portion 11, when the latching end 79 is just touched carelessly by an operator. The recessed receiving portions 83, 83 have circumferential opposite ends widening in an opposite axial direction. Opposed inner surface 87, 87 of the retainer 5 in arcuate cross-section which extend from the operation arms 77, 77 to the engagement slits 81, 81 are generally tapered respectively in one axial direction toward the center or the central a of the retainer 5. And then the retainer 5 is configured so that the annular engagement projection 73 of the pipe 71 necessarily or substantially necessarily abuts the tapered inner surfaces 87, 87 of the retainer 5 at boundaries between the operation arms 77, 77 and the main body 63 when the pipe 71 is inserted in the main body 63 of the retainer 5 through the end of the latching ends 79, 79 of the operation arms 77,77. Reference numeral 89 in FIG. 2 indicates an anti-rotation raised portion which is formed integrally on an inner peripheral surface of the retainer holding portion 11 and fits in the notched portion 75 of the main body 63 of the retainer 5 to restrain the retainer 5 from rotational movement and rattling in the retainer holding portion 11.

As well shown in FIG. 5, the pipe 71 to be joined with the tube, made of metal is inserted into an insertion opening 91 on an end of the retainer holding portion 11, more specifically, in the main body 63 of the retainer 5 through the end of the latching ends 79, 79 of the operation arms 77, 77, and is to be fitted in the first quick connector 1. The pipe 71 has an inserting end portion 93 on one axial end wherein the annular engagement projection 73 is formed on an outer peripheral surface. The pipe 71 is pushed, and fittingly inserted into the first quick connector 1 or the tubular connector housing 3 so that the annular engagement projection 73 progresses radially expanding an inner surface of the main body 63 of the retainer 5 until the annular engagement projection 73 seats in the engagement slits 81, 81 in snap-engagement relation therewith. The annular engagement projection 73 which seats and snap-engages in the engagement slits 81, 81 of the main body 63 of the retainer 5 blocks or limits further axial in-and-out movement of the pipe 71 with respect to the first quick connector 1. That is, the pipe 71 is thereby almost locked against relative axial movement in the first quick connector 1. One axial end or edge, or an inserting end or edge of the pipe 71 reaches in the first resin bush 37 fitted in the resin tube connecting portion 9 through the third O-ring 45, the second O-ring 33 and the first O-ring 31, and thereby a seal is formed by the fist to the third O-rings 31, 33, 45 between an outer peripheral surface of the pipe 71 and an inner peripheral surface of the first quick connector 1, more specifically, between an outer peripheral surface of one axial end of the annular engagement projection 73 of the inserting end portion 93 of the pipe 71 and an inner peripheral surface of the resin tube connecting portion 9. The one axial end of the annular engagement projection 73 of the inserting end portion 93 of the pipe 71 is fittingly inserted without play in the second resin bush 47, the inwardly directed annular parting projection 25 and the first resin bush 37 having inner diameters generally identical to an outer diameter of the inserting end portion 93 of the pipe 71. The retainer 5 is usually fitted slightly loosely in the retainer holding portion 11 with slight axial play therein. However, at least when the pipe 71 is fully inserted therein, one axial end of the main body 63 is in abutment relation or close proximity relative to the annular abutment surface 55 and the annular end surface 53 of an opposite axial end of the second resin bush 47. And, an overlapping length (axial overlapping length) of a cylindrical outer peripheral surface (excluding tapered outer peripheral surface) of the pipe 71 and the first resin bush 37 is ranging from 0.3 mm to 10 mm, preferably is a minimum of 5.0 mm. Or, a length (axial length) of lly-overlapping portion of a cylindrical outer peripheral surface (excluding tapered outer peripheral surface) of the pipe 71 and the first resin bush 37 is ranging from 0.3 mm to 10 mm, preferably is a minimum of 5.0 mm.

In the event of removing the pipe 71 from the first quick connector 1, the latching ends 79, 79 of the operation arms 77, 77 received in the recessed receiving portions 83, 83 are pressed radially inwardly from outside to narrow a radial space between the operation arms 77, 77, thus a radial space between the engagement tabs 67, 67. And, thereby the engagement tabs 67, 67 are out of the engagement windows 57, 57, and the retainer 5 can be relatively pulled out of the tubular connector housing 3. As the retainer 5 is relatively pulled out of the tubular connector housing 3, the pipe 71 is also pulled out of the first quick connector 1 or the tubular connector housing 3 along with the retainer 5.

A resin tube 95 is connected to the resin tube connecting portion 9 of the tubular connector housing 3. The resin tube 95 is formed so as to have an inner diameter smaller than an outer periphery of the resin tube connecting portion 9, therefore smaller than an outer peripheral surface of one axial end of the annular engagement portion 39 of the first bush 37. So, by relatively force-fitting the resin tube connecting portion 9 in a fit-on side of the resin tube 95, the resin tube 95 is connected to the resin tube connecting portion 9 while tightly fitted thereon. As clearly shown in FIG. 5, the resin tube 95 fitted thereon gives an intimate contact entirely with an outer peripheral surface of the one aal end of the annular engagement portion 39 of the first bush 37, and fastens entirely the outer peripheral surface of the one axial end thereof. An opposite axial end or edge (an opening end) of a fit-on portion 97 (a portion fitted on the outer periphery of the resin tube connecting portion 9) of the resin tube 95 reaches an opposite axial end, edge or edge portion of the resin tube connecting portion 9 to abut an annular end surface 99 formed on an opposite axial end, edge or edge portion of the resin tube connecting portion 9 so as to spread radially outwardly. That means, the opposite axial end of the fit-on portion 97 of the resin tube 95 is located on an opposite end axially from the first O-ring 31 and the second O-ring 33, or beyond the first O-ring 31 and second O-rings 33 in an opposite axial direction. Here, the resin tube 95 is fitted on the resin tube connecting portion 9 so that the opposite axial end of the fit-on portion 97 of the resin tube 95 corresponds to the third O-ring 45 in an axial position. However, sometimes, the resin tube 95 can be fitted on the resin tube connecting portion 9 so that the opposite axial end of the fit-on portion 97 is located on one end axially of the third O-ring 45.

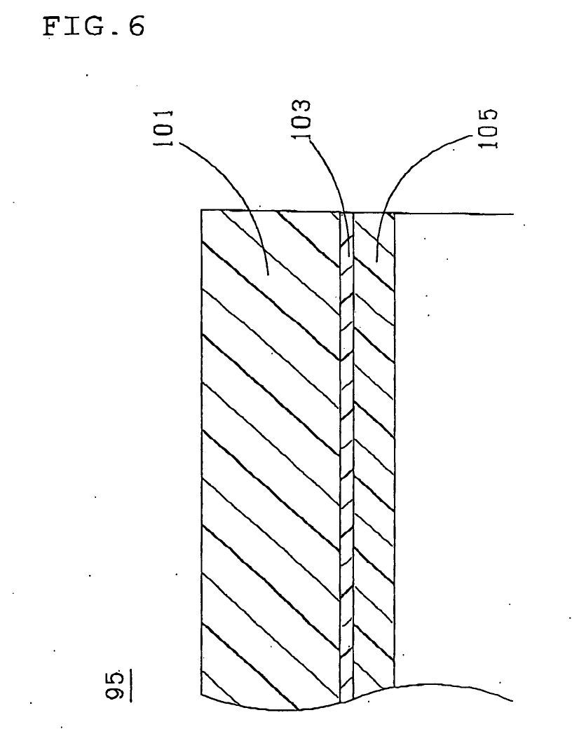

The connector housing 3 may be formed from base material of PA 12 which is reinforced by glass fiber (GF). Or, the connector housing 3 may be formed from base material of poly phenylene sulfide (PPS), for example, with specific gravity of 1.65, which is reinforced by glass-fiber, so as to have a flexural modulus, for example, of at minimum 1500 MPa according to ASTM D790. The resin tube 95 may have multi-layered construction, as shown in FIG. 6, including an outer layer 101 of which base material is PA12 with heat resistance, a middle layer 103 of which base material is acid-modified polypropylene (PP) and an inner gas barrier layer 105. Base material of the inner gas barrier layer 105 may be PA11 (for example, specific gravity 1.05), ethylene tetrafluoroethylene (ETFE)(for example, a specific gravity 1.75), PPS (for example, specific gravity 1.65) or polybutylene phthalate (PBN)(for example, specific gravity 1.33).

Here, the resin tube 95 and the first quick connector 1 are formed from various or some base materials respectively to construct a connecting portion. And, gasoline fuel permeation amount is measured at connecting region of the resin tube 95 and the first quick connector 1 respectively. The results are shown in Table 1. The resin tube 95 has multi-layered construction of 1.4 mm in wall-thickness and is formed with 34.5 mm in outer diameter and 216.0 mm in length. The multi-layered construction includes an outer layer of 10 mm in wall-thickness, a middle layer of 0.1 mm in wall-thickness and an inner gas barrier layer of 0.3 mm in wall-thickness. In each of the resin tubes 95 which are prepared here, base material of the outer layer is PA12, and base material of the middle layer is acid-modified PP. And, as for the inner gas barrier layer, PA11 (specific gravity 1.05), ETFE (specific gravity 1.75), PPS (specific gravity 1.65) and PBN (specific gravity 1.33) are used as base material respectively. The first quick connector 1 here has the connector housing 3 which is formed from base material of resin, which is reinforced by glass fiber, is adapted for the pipe 71 of 28.6 mm in outer diameter. In the first quick connectors 1 which are prepared here, the connector housings 3 are formed using PA12, glass-fiber-reinforced (GF), and PPS, glass-fiber-reinforced (GF) as base material, respectively. The connector housing 3 from PA12GF is adjusted to have a flexural modulus of 6310 MPa by using base material PA12 of a specific gravity of 1.23, and that from PPSGF is adjusted to have a flexural modulus of 8500 MPa by using base material PPS of a specific gravity of 1.65.

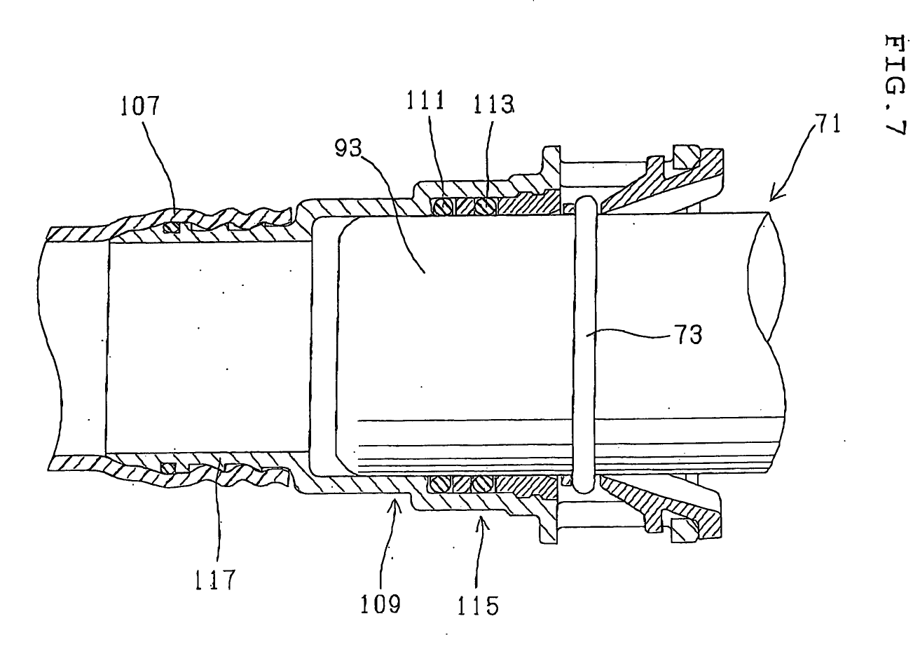

In a comparison example, a resin tube 107 and a conventional quick connector 109 are also formed from various or some materials respectively to construct a connecting portion as shown in FIG. 7, where the resin tube 107 is fitted on the conventional quick connector 109 so as to define an axial distance between the resin tube 107 and first and second O-rings 111, 113 in the conventional quick connector 109. The resin tube 107 is formed smaller than the resin tube 95 in inner diameter, but has the same multi-layered construction as the resin tube 95. The conventional quick connector 109 has the connector housing 115 which is formed from base material of resin, which is reinforced by glass fiber, is adapted for the pipe 71 of 28.6 mm in outer diameter. In the conventional quick connectors 109 which are prepared here, the connector housings 115 are formed using PA12, glass-fiber-reinforced (GF), and PPS, glass-fiber-reinforced (GF) as base material, respectively, just like in the first quick connectors 1. And, each of the connector housings 115 is adjusted to have the same flexural modulus as in the first quick connector 1 by using PA 12 and PPS of the same specific gravity as in the first quick connector 1.

The predetermined resin tubes 95, 107 are fitted on resin tube connecting portions 9, 117 of the quick connectors 1 and the conventional quick connector 109 respectively, and the pipes 71 are inserted in and connected to the quick connector 1 and the conventional quick connector 109 respectively. And, gasoline fuel is enclosed in the thus constructed connecting regions including connector connecting portions (connector housing regions). And, gasoline fuel permeation amount through one end regions of the resin tubes 95, 107 extending axially from one axial ends of the resin tube connecting portions 9, 117 is measured (the results are shown in the column of “resin tube gas” in Table 1), and gasoline fuel permeation amount through portions extending axially from one ends of the resin tube connecting portions 9, 117 to the first O-rings 31, 111 is measured (the results are shown in the column of =connector housing” in Table 1). Flexural modulus is measured according to ASTM D790.

TABLE 1

| | | | Example | | | Comparative example | | |
|---|---|---|---|---|---|---|---|---|
| | | Resin tube gas | Permeation amount | | | Permeation amount | | |
| Connector housing | | barrier layer | (mg/day) | | | (mg/day) | | |
| Specific | Flexural | Specific | Connector | Resin | | Connector | Resin | |
| gravity | modulus (MPa) | gravity | housing | tube | Total | housing | tube | Total |

| | | | | | | | | |
|---|---|---|---|---|---|---|---|---|
| 1 | PA12GF | PA11 | 1.7 | 400 | 401.7 | 6.5 | 400 | 406.5 |

| | | |
|---|---|---|
| 1.23 | 6310 | 1.05 |

| | | | | | | | | |
|---|---|---|---|---|---|---|---|---|
| 2 | PA12GF | ETFE | 1.7 | 9.6 | 11.3 | 6.5 | 9.6 | 16.1 |

| | | |
|---|---|---|
| 1.23 | 6310 | 1.75 |

| | | | | | | | | |
|---|---|---|---|---|---|---|---|---|
| 3 | PA12GF | PPS | 1.7 | 0.8 | 2.5 | 6.5 | 0.8 | 7.3 |

| | | |
|---|---|---|
| 1.23 | 6310 | 1.65 |

| | | | | | | | | |
|---|---|---|---|---|---|---|---|---|
| 4 | PPSGF | PPS | 1.7 | 0.8 | 2.5 | 1.7 | 0.8 | 2.5 |

| | | |
|---|---|---|
| 1.65 | 8500 | 1.65 |

| | | | | | | | | |
|---|---|---|---|---|---|---|---|---|
| 5 | PPSGF | PBN | 1.7 | 0.8 | 2.5 | 1.7 | 0.8 | 2.5 |

| | | |
|---|---|---|
| 1.65 | 8500 | 1.33 |

As understood from Table 1, in case that base material of gasoline fuel impermeability (gas impermeability) such as PPS is used for the connector housing, there is no difference with respect to gasoline fuel permeation amount between the connecting structure with the first quick connector 1 and the connecting structure with the conventional quick connector 109.

However, when base material of PA12 which is inferior in gasoline fuel impermeability is used for the connector housing, gasoline fuel permeation amount through a connector housing region or “connector housing” region in the Example is approximately 25% of that in the Comparative Example. As for gasoline fuel permeation amount through whole of the connecting structure or connecting region or “total” region, if base material of the inner gas barrier layer of the resin tubes 95, 107 is PPS which is excellent in gasoline fuel impermeability, gasoline fuel permeation amount in the Example is approximately 35% of that in the Comparative Example. And, if base material of the inner gas barrier layer of the resin tubes 95, 107 is ETFE which is relatively excellent in gasoline fuel impermeability, gasoline fuel permeation amount in the Example is approximately 70% of that in the Comparative Example. Here, base material of the connector housing 3 has a specific gravity of at minimum 1.2 and at maximum 2.0, the connector housing 3 has a flexural modulus of at minimum 1500 MPa, and base material of the inner gas barrier layer of the resin tube 95 has a specific gravity of at minimum 1.2 and at maximum 2.0. However, if base material of the inner gas barrier layer of the resin tubes 95, 107 is such as PA 11 which is inferior in gasoline fuel impermeability, there is almost no difference with respect to gasoline fuel permeation amount through whole of the connecting region between the Example and the Comparative Example.

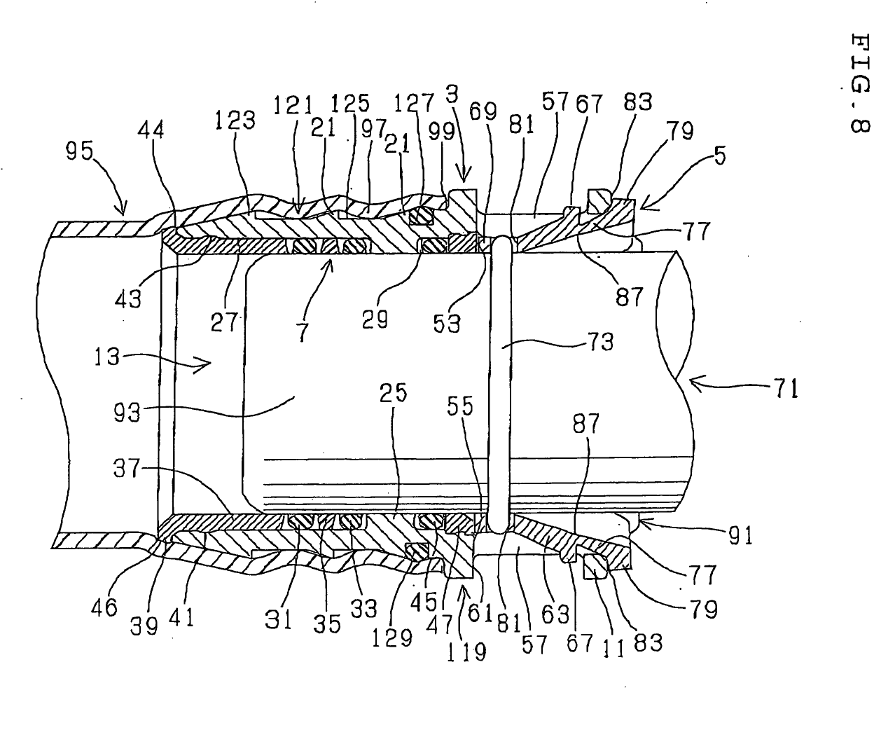

A second quick connector 119 shown in FIG. 8, which is used in a connecting structure for piping according to the present invention, is adapted for assembly for a gasoline fuel piping of an automobile, just like the first quick connector 1. The second quick connector 119 is configured by modifying outer configuration of the resin tube connecting portion 9 of the first quick connector 1. As other configuration is the same as the first quick connector 1, generally identical reference numerals are given and explanations are omitted with regard to the portions having identical configuration to the first quick connector 1.

A resin tube connecting portion 121 of the second quick connector 119 also has one axial end portion 123 like right triangle in cross-section having an outer peripheral surface expanding gently in diameter toward an opposite axial end of the resin tube connecting portion 121, but the one axial end portion 123 extends somewhat longer in the opposite axial end compared to the one axial end portion 15. An outer surface of the one axial end portion 123 is continuously connected to an outer peripheral surface of an opposite axial end portion 125, and no annular groove is formed at bordering portion between the one axial end portion 123 and the opposite axial end portion 125. The opposite axial end portion 125 has an outer peripheral surface which is provided with a deep annular groove 127 on an opposite end portion thereof, and an annular seal 129 (hermetically-closing means) is fitted in the deep annular groove 127. The annular seal 129 provides a seal between the resin tube connecting portion 121 and an opening end or opening end portion of the resin tube 95. The deep annular groove 127 may be shaped, for example, like square or rectangular in cross-section.

In the second quick connector 119, it can be effectively prevented that gasoline fuel which passed through the resin tube connecting portion 121 is discharged from an opening end of the resin tube 95 through between the resin tube connecting portion 121 and a fit-on is portion 97 of the resin tube 95. Therefore, further excellent gasoline fuel impermeability may be expected from the second quick connector 119 compared to the first quick connector 1.

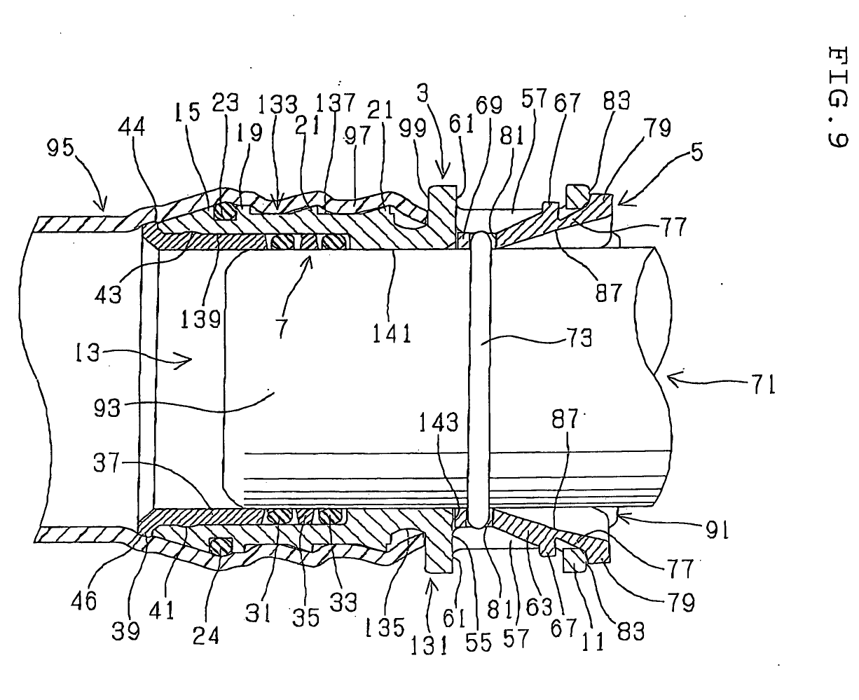

A third quick connector 131 shown in FIG. 9, which is used in a connecting structure for piping according to the present invention, is adapted for assembly for a gasoline fuel piping of an automobile, just like the first quick connector 1. The third quick connector 131 is configured by modifying the resin tube connecting portion 9 of the first quick connector 1, specifically inner configuration thereof. As other configuration is the same as the first quick connector 1, generally identical reference numerals are given and explanations are omitted with regard to the portions having identical configuration to the first quick connector 1.

The third quick connector 131 has a resin tube connecting portion 133 where an outer peripheral surface 135 on an opposite axial end of an opposite axial end portion 137 (a portion from a somewhat opposite axial end of the annular projecting stop portion 21 on the opposite axial end to the retainer holding portion 11) is formed further in small diameter or into a deep groove compared to the outer peripheral surface 23 on one axial end thereof.

An inner peripheral surface of the resin tube connecting portion 133 includes a receiving portion 139 on one axial end and a small diameter portion 141 on an opposite axial end. The receiving portion 139 has identical configuration to the first receiving portion or large diameter portion 27 of the fist quick connector 1. In the receiving portion 139, a pair of O-rings 31, 33 are fitted with intervening a collar 35 therebetween, in axially spaced and side-by-side relation with one another, likewise in the fist receiving portion 27 of the first quick connector 1. The first O-ring 31 is made of FKM, but may be made of FKM/FVMQ. The second O-ring 33 is made of FVMQ, but may be made of NBR or NBR/PVC. The small diameter portion 141 has an inner diameter generally equal to an outer diameter of the pipe 71, and is formed so as to define a whole inner surface of an opposite axial end of the resin tube connecting portion 133. An annular opposite end suite 143 on an opposite axial end of the small diameter portion 141 is located to share a plane common with the annular abutment surface 55 which is formed on one axial end of inside of the ret holding portion 11 and expands radially inwardly with small width. And one axial ends or one axial end surfaces 61, 61 of the engagement windows 57, 57 of the retainer holding portion 11 are located to share a plane common with the annular abutment surface 55 of inner side of the retainer holding portion 11. That is, no step or stepped portion is defined on a surface between the one anal end 61 of the engagement window 57 and the annular opposite end surface 143 of an opposite axial end of the small diameter portion 141.

The pipe 71 is pushed, and fittingly inserted into the third quick connector 131 so that the annular engagement projection 73 seats in the engagement slits 81, 81 of the main body 63 of the retainer 5 in snap-engagement relation therewith, likewise in the first quick connector 1. The annular engagement projection 73 which seats and snap-engages in the engagement slits 81, 81 of the main body 63 of the retainer 5 blocks or limits further axial in-and-out movement of the pipe 71 with respect to the third quick connector 131. That is, the pipe 71 is thereby almost locked against relative axial movement in the third quick connector 131. One axial end of the pipe 71 reaches in the first resin bush or resin bush 37 fitted in the resin tube connecting portion 133 through a pair of the O-rings (the first and second O-rings) 31, 33 provided in the resin tube connecting portion 133. A seal is essentially formed only by the first and second O-rings 31, 33 between an outer peripheral surface of the pipe 71 and an inner peripheral surface of the third quick connector 131.

The third quick connector 131 is estimated to have the same gasoline fuel impermeability as the first quick connector 1 or equivalent degree of the gasoline fuel impermeability to the first quick connector 1, although the third quick connector 131 has a simple configuration without the third O-ring 45.

The connecting structure for piping according to the present invention, which is adapted, for example, in an engine room of an automobile, is able to achieve excellent impermeability to gasoline fuel or the like.

1. A connecting structure for piping to connect a tube and a pipe by way of a quick connector and to establish fluid communication path, comprising:
a quick connector having a tubular connector housing provided with a tube connecting portion on one axial end thereof and a retainer portion on an opposite axial end thereof, retainer means provided to the retainer portion and sealing means disposed in the tubular connector housing;
a pipe including an inserting end portion provided with an annular engagement projection, the pipe being inserted into an insertion opening on so an end of the tubular connector housing and connected to the tubular connector housing so that the annular engagement projection snap-engages with the retainer means and a seal is provided between the tubular connector housing and one end of the inserting end portion extending axially from the annular engagement projection of the pipe by the sealing means;
a tube including a fit-on portion tightly fitted on an outer periphery of the tube connecting portion of the tubular connector housing, an opposite axial end of the fit-on portion of the tube being located on an opposite end axially of the sealing means; and
the tubular connector housing being made of resin and the tube having a barrier property or barrier layer against gasoline fuel or the like.

2. The connecting structure for piping as set forth in claim 1 wherein hermetically-closing means is disposed on an outer periphery of the tube connecting portion to provide a seal with respect to the fit-on portion of the tube, and the hermetically-closing means is located so as to provide a seal between an opposite axial end portion of the fit-on portion of the tube and the tube connecting portion.

3. The connecting structure for piping as set forth in claim 1 wherein base material of the tube has a specific gravity ranging from 1.2 to 2.0.

4. The connecting structure for piping as set forth in claim 3 wherein base material of the tubular connector housing has a specific gravity ranging from 1.2 to 2.0 and a flexural modulus of the tubular connector housing is set at minimum 1500 Mpa according to ASTM D790.

5. The connecting structure for piping as set forth in claim 1 wherein a bush is fitted in an inside of the tube connecting portion on one axial end thereof, one axial end portion of the bush projects in one axial direction beyond one axial end of the tube connecting portion and is dimensioned larger than the one axial and of the tube connecting portion in outer diameter, and the fit-on portion of the tube is fitted on the tube connecting portion so as to fasten tightly the one axial end portion of the bush.

6. The connecting structure for piping as set forth in claim 5 wherein a flexural modulus of the tubular connector housing is set at minimum 1500 Mpa according to ASTM D790.
